(19) United States
(12) Patent Application Publication
(10) Pub. No.: US 2026/0369011 A1
(43) Pub. Date: Nov. 19, 2026

(54) GEOMETRY-AWARE MONOCULAR 3-D FACE RECONSTRUCTION

(71) Applicant: Microsoft Technology Licensing, LLC, Redmond, WA (US)

(72) Inventors: Lohit Dev PETIKAM, Cambridge (GB); Charles Thomas HEWITT, Cambridge (GB); Mohammad Sadegh ALI AKBARIAN, Cambridge (GB); Fatemehsadat SALEH, Cambridge (GB); Tadas BALTRUSAITIS, Cambridge (GB)

(21) Appl. No.: 19/209,946

(22) Filed: May 16, 2025

(51) Int. Cl. G06T 17/20; G06V 10/26; G06V 10/764; G06V 10/77; G06V 10/774; G06V 10/82; G06V 40/16

(52) U.S. Cl. CPC G06T 17/205; G06V 10/26; G06V 10/764; G06V 10/7715; G06V 10/774; G06V 10/82; G06V 40/171; G06V 40/172

(57) ABSTRACT

Techniques for generating three-dimensional face meshes from single two-dimensional images using geometry-aware neural networks are described. A Vision Transformer processes image patches to generate visual tokens and a compressed classification token. Surface normal features representing facial geometry are extracted through a specialized estimation head, while dense two-dimensional landmark coordinates for key facial features are predicted using the classification token. Grid sampling combines the visual tokens and surface normal features at landmark locations to create rich geometric representations. These combined features drive generation of identity parameters that control deformation of a parametric face model template, producing detailed three-dimensional meshes. The techniques enable real-time face reconstruction without requiring camera information or multiple views, while maintaining high accuracy through training on synthetic data. The resulting meshes preserve facial proportions and fine geometric details, making them suitable for augmented reality, virtual reality, and avatar creation applications.

### TECHNICAL FIELD

The present disclosure relates to techniques for three-dimensional (3-D) face reconstruction from a single image, and more particularly to neural network architectures for generating accurate and plausible three-dimensional face shapes using geometry-aware techniques. The technical field specifically encompasses computer vision and machine learning approaches for estimating facial identity parameters, surface normals, and dense landmarks to create detailed three-dimensional mesh representations suitable for augmented reality, virtual reality, avatar creation, and character generation applications.

### BACKGROUND

Advancements in computing technology, including increased processing power, expanded memory capacity, and improved graphical rendering capabilities, have enabled the development of increasingly sophisticated virtual environments. These environments often include representations of users or other entities, which may be visualized in two or three dimensions, animated in real time, and presented in interactive settings. As a result, computing systems are now capable of rendering detailed virtual worlds and objects with a high degree of realism and responsiveness, supporting dynamic interaction across a broad range of use cases.

In parallel with these developments, systems have been designed to support the creation and manipulation of virtual representations of users, commonly referred to as avatars. Such avatars can be utilized across a wide variety of digital contexts, including video games, virtual reality (VR), augmented reality (AR), and real-time communications platforms. These representations may take on various forms, from photorealistic images to stylized graphical figures, and may be rendered and displayed in response to user input or in conjunction with other data sources. As a result, users are increasingly able to participate in virtual spaces in ways that reflect individual identity, presence, and activity.

### BRIEF DESCRIPTION OF THE DRAWINGS

Embodiments of the present invention are illustrated by way of example and not limitation in the figures of the accompanying drawings, in which:

FIG. 1 illustrates a parametric face model showing the progression from a template face to faces with added identity parameters, and further showing how additional expression and pose parameters can modify the face appearance, consistent with some embodiments.

FIG. 2 illustrates examples of synthetic training data used to train a neural network model, showing a synthetic face image with corresponding face parameters including identity, expression, and pose, consistent with some embodiments.

FIG. 3 illustrates a neural network architecture for geometry-aware monocular 3-D face reconstruction, showing components for patch generation, vision transformer encoding, surface normal estimation, landmark prediction, grid sampling, and identity parameter generation, consistent with some embodiments.

FIG. 4 illustrates a flowchart showing a method for generating a three-dimensional mesh representation of a face from a two-dimensional image, including steps for patch extraction, feature encoding, surface normal feature generation, landmark prediction, feature sampling, and identity parameter generation, consistent with some embodiments.

FIG. 5 illustrates a software architecture that may be installed on a machine for implementing the geometry-aware 3-D face reconstruction system, showing various application layers, frameworks, libraries, and operating system components, consistent with some embodiments.

FIG. 6 illustrates a diagrammatic representation of machine components and I/O interfaces that may be used to implement the 3-D face reconstruction system, including processors, memory, and various input/output components, consistent with some embodiments.

### DETAILED DESCRIPTION

Described herein are techniques for generating accurate and plausible three-dimensional face shapes from a single image using a unified neural network model with geometry-aware features. The techniques set forth herein enable high-quality three-dimensional (3-D) face reconstruction through an approach that combines dense two-dimensional landmarks, surface normals, and visual features to recover detailed facial geometry without requiring camera information, multiple views or images, or other constraints. Rather than relying on traditional iterative optimization-based methods that require multiple images captured from different angles, the disclosed approach leverages a single-shot, fully data-driven solution trained entirely on synthetic data. This synthetic training data provides mathematically perfect ground truth information that would be difficult, if not impossible, to obtain accurately through conventional multi-camera setups with real subjects, even with hundreds of cameras. The system utilizes a neural network architecture with specialized components for patch extraction, feature encoding, surface normal estimation, landmark prediction, and grid sampling to generate accurate three-dimensional mesh representations in real-time. The surface normal estimation component serves as a critical geometric proxy that enables the model to better preserve facial proportions and capture fine details like wrinkles, resulting in significantly improved likeness to the input image compared to conventional approaches. This technology is particularly suitable for augmented reality, virtual reality, and avatar creation applications where accurate facial representation from a single image is essential. In the following description, numerous specific details are provided, including techniques for feature extraction, methods for surface normal estimation, and approaches for identity parameter prediction. These details enable one skilled in the art to practice the disclosed embodiments. It will be apparent, however, to one skilled in the art that the disclosed embodiments may be practiced without these specific details.

Generating accurate and plausible three-dimensional face shapes from a single two-dimensional image presents significant technical challenges that conventional approaches have struggled to address effectively. Creating three-dimensional face geometry that accurately represents an identity of a user requires technical solutions that can extract and interpret complex geometric information from limited 2-D input data. While conventional approaches can produce basic 3-D face reconstructions, they often fail to capture the subtle facial proportions and fine details that make a face recognizably unique to an individual.

Conventional approaches to three-dimensional face reconstruction are limited by several technical constraints. Traditional model fitting techniques employ iterative optimization processes that attempt to fit parametric models to 2-D observations. These methods require substantial computational resources as they repeatedly adjust parameters to minimize error between the model and observed data. This iterative process can take significant time—often seconds or minutes per reconstruction—making them impractical for real-time applications such as augmented reality experiences. Furthermore, these approaches typically require multiple images captured from different angles to achieve reasonable accuracy, creating a cumbersome user experience that limits practical deployment.

The acquisition of high-quality training data represents another significant technical challenge. Conventional approaches that rely on real-world data typically require elaborate multi-camera setups to capture facial geometry from multiple angles simultaneously. These physical infrastructure requirements can cost hundreds of thousands of dollars to implement properly, yet still produce imperfect results. Surface normal data—vectors representing the orientation of the face surface at each point—is particularly challenging to capture accurately from real subjects. Even sophisticated multi-camera systems struggle to produce consistent and accurate surface normal measurements due to inherent limitations in physical camera systems, including lighting variations, calibration issues, and sensor noise. This data acquisition challenge creates a significant barrier to developing high-quality 3-D face reconstruction systems.

Conventional neural network approaches that directly predict identity parameters without incorporating geometric understanding represent another technical limitation. While these approaches can generate reasonable 3-D face shapes, they often lack the ability to preserve accurate facial proportions and fine details like wrinkles and subtle contours. This limitation stems from their inability to effectively leverage geometric information that helps the model understand the 3-D structure of the face before predicting identity parameters. The surface normal information, which provides critical cues about facial geometry, is particularly valuable but difficult to incorporate effectively in conventional approaches.

Privacy concerns present an additional challenge when developing face reconstruction systems. Conventional approaches that rely on training with real facial image data raise significant privacy and ethical considerations. Collecting, storing, and processing real human face data requires careful handling of personally identifiable information and may be subject to various regulatory requirements. These privacy concerns can significantly complicate the development and deployment of 3-D face reconstruction systems, particularly for applications that may be used globally under different privacy regulations.

The technical complexity is further compounded by the need to disentangle identity parameters from other variables like head pose and expressions to generate accurate face shapes. A comprehensive solution must address the technical challenge of extracting and utilizing geometric information from limited 2-D input data while maintaining consistency between different geometric representations. This requires sophisticated neural network architectures that can effectively integrate multiple types of geometric information and produce coherent 3-D reconstructions that accurately capture a person's identity.

To address the several technical problems described above, consistent with some embodiments, the techniques set forth herein provide an innovative unified neural network architecture that generates accurate three-dimensional face shapes from a single two-dimensional image in real-time. This solution represents a significant technical advancement over conventional approaches by integrating geometric understanding directly into the reconstruction process.

Consistent with some embodiments, the techniques employs a single, end-to-end trained neural network model that processes input images through multiple specialized layers working in concert. The process begins with a patch extraction layer that divides the input image into non-overlapping pixel patches of a predetermined size (e.g., 16×16). While this patch extraction is a pre-processing step rather than a neural network layer itself, it provides an efficient representation for subsequent processing. These patches are then vectorized and embedded through an embedding layer, which also generates a classification embedding token representing the entire image.

A key technical innovation, consistent with some embodiments, is the geometry-aware approach that incorporates multiple types of facial information. Unlike conventional methods that directly predict identity parameters from image features, the architecture includes a geometric feature extraction layer that analyzes visual tokens to extract surface normal features representing the three-dimensional geometry of the face in image space. This surface normal information serves as an important proxy to the geometry of the face, enabling the model to better understand 3-D structure before predicting identity parameters. Additionally, the system processes the compressed classification token through a landmark prediction layer to generate two-dimensional landmark coordinates that identify important facial features such as eye corners, lip boundaries, eyebrows, and jaw positions.

Consistent with some embodiments, the model employs a novel grid sampling mechanism that combines both visual and geometric information at specific facial landmark locations. This targeted feature extraction focuses the model on the most informative regions of the face, allowing it to ignore background elements and concentrate on parts of the face that truly define a person's identity. The combined feature vectors are then processed through an identity parameter generation layer that transforms them into identity parameters for a parametric face model, which are used to deform a template mesh according to the facial identity of the person in the two-dimensional image.

The techniques set forth herein provide several significant technical advantages over conventional approaches. By implementing the entire process as a single neural network trained end-to-end, the system can generate 3-D face meshes in real-time—dramatically faster than traditional methods that rely on iterative optimization. This real-time performance makes the technology particularly valuable for augmented reality and virtual reality applications, where users can instantly generate realistic avatars from a single selfie image. The ability to create accurate 3-D representations in real-time enables applications such as immersive communication, where participants can be represented by realistic avatars that capture their unique facial identity.

Consistent with some embodiments, the use of synthetic training data provides additional technical advantages. The synthetic data approach eliminates the need for expensive multi-camera setups that would otherwise be required to capture real-world training data with corresponding ground truth information. By training on synthetic data, the system has access to mathematically perfect ground truth information, including precise surface normal vectors and landmark positions that would be impossible to measure accurately from real photographs. This approach also addresses privacy concerns associated with collecting and using real human face data, making it possible to develop robust solutions without compromising user privacy.

The effectiveness of the presented techniques are demonstrated through the ability to preserve facial proportions and capture fine details like wrinkles, leading to better likeness compared to conventional approaches. The surface normal features enable the model to better understand the subtle geometry of the face, resulting in more accurate reconstructions that maintain the unique characteristics of the individual. This makes the system particularly valuable for applications in augmented reality, virtual reality, avatar creation, and character generation where accurate facial representation is crucial for user engagement and immersion.

Consistent with some embodiments, the training process employs multiple specialized loss functions working in concert to ensure accuracy across different aspects of face reconstruction. A landmark loss function using Gaussian Negative Log-Likelihood optimizes landmark prediction accuracy. Surface normal loss ensures geometric accuracy through cosine similarity between predicted and ground-truth normal vectors. Identity and mesh losses work together to ensure the final 3-D representation accurately captures the identity of a person while maintaining proper facial proportions. This comprehensive training approach results in a model that can generate high-quality 3-D face meshes from a single image with unprecedented accuracy and efficiency. Other aspects and advantages of the various embodiments will be readily apparent from the detailed descriptions of the several figures that follows.

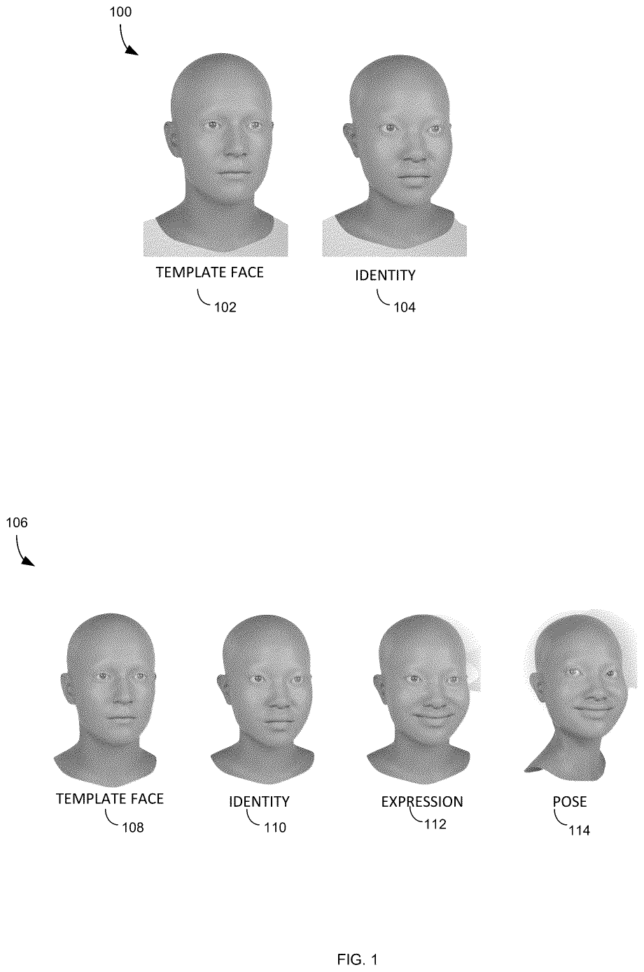

FIG. 1 illustrates a parametric face model that demonstrates how a three-dimensional face representation is generated through the application of various parameters. The figure is divided into two main sections, identified by reference numbers 100 and 106, each showing different aspects of the parametric face model. In the upper portion of FIG. 1, identified by reference number 100, two face representations are shown. The left image, labeled “Template Face” and identified by reference number 102, depicts a generic three-dimensional face mesh that serves as the starting point for face reconstruction. This template face 102 is not unique to any particular person but rather represents a standardized base model that can be deformed to match specific facial identities. The template face 102 is designed to be neutral in expression and pose, providing a consistent starting point for the face reconstruction process.

The right image in the upper portion, identified by reference number 104, shows how the template face is modified when identity parameters are applied. These identity parameters deform the template mesh to take on the unique facial characteristics of a specific person. The transformation from the template face 102 to the identity-modified face 104 demonstrates how the parametric model captures the distinctive facial structure, proportions, and features that make each person's face recognizable and unique.

The lower portion of FIG. 1, identified by reference number 106, expands on this concept by illustrating how additional parameters can further modify the face beyond just identity. This section shows four face representations that demonstrate the progressive application of different parameter types. The first image, labeled “Template Face” and identified by reference number 108, again shows the generic template mesh. The second image, labeled “Identity” and identified by reference number 110, shows the template with identity parameters applied, similar to reference number 104 in the upper portion.

The third image, labeled “Expression” and identified by reference number 112, demonstrates how expression parameters can be added to the identity-modified face to capture facial expressions such as smiling or frowning. The expression parameters control the deformation of facial muscles and features to represent different emotional states while maintaining the underlying identity of the person.

The fourth image, labeled “Pose” and identified by reference number 114, shows the final modification where head pose parameters are applied to the face model. These pose parameters control the orientation and position of the head in three-dimensional space, allowing the face to be rotated and positioned as needed.

Consistent with some embodiments, this parametric face model is fundamental to the three-dimensional face reconstruction process. The neural network model, in some examples, is specifically designed to generate the identity parameters from a single two-dimensional image, which are then applied to the template mesh to create an accurate three-dimensional representation of the person's face. The innovative technique focuses specifically on extracting the identity parameters while maintaining neutral expression and pose by setting the expression and pose parameters to zero during the mesh generation process. This approach ensures that only the unique facial identity characteristics are captured in the final three-dimensional mesh representation, without any influence from facial expressions or head positioning.

This parametric approach allows the system to generate realistic and accurate three-dimensional face meshes that capture the unique identity of individuals from a single two-dimensional image, making it particularly valuable for applications in augmented reality, virtual reality, and digital avatar creation.

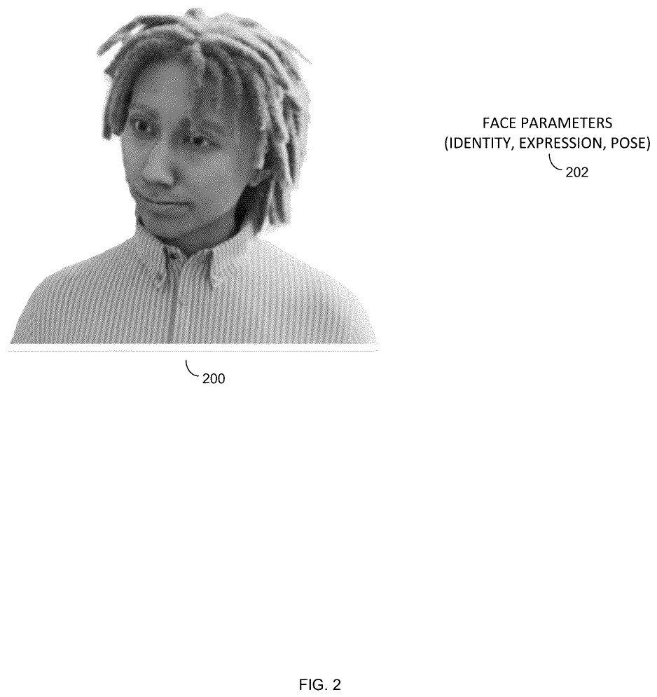

FIG. 2 illustrates an example of synthetic training data used to train the neural network model for 3-D face reconstruction. The figure shows a synthetic face image 200 along with corresponding face parameters 202 including identity, expression, and pose information. This synthetic data plays an important role in the training process of the neural network model.

The synthetic data approach represents a significant improvement over conventional techniques for 3-D face reconstruction. By using computer-generated face images with precisely known parameters, the model can be trained with perfect ground truth information that would be extremely difficult if not impossible to obtain through traditional means. Each synthetic face is annotated with exact identity parameters that control the shape of the face, allowing the neural network to learn the relationship between 2-D image features and 3-D facial geometry with extreme accuracy.

Beyond the visible image data, the synthetic dataset includes rich metadata such as dense 2-D face landmarks, surface normal maps, and depth information. These additional annotations enable the model to learn intermediate representations of facial geometry that serve as “stepping stones” toward accurate identity parameter prediction. The surface normal data, which represents the orientation of the face surface at each point, is particularly valuable as it provides important geometric information that helps the model understand the 3-D structure of the face.

Conventional approaches to obtaining such comprehensive training data would require complex multi-camera setups that capture real people from multiple angles simultaneously. These physical setups not only require expensive specialized equipment but also necessitate recruiting real human subjects for photography sessions. Even with elaborate arrangements of hundreds of cameras positioned at different angles around a real person, the captured data contains significant inaccuracies and inconsistencies due to lighting variations, camera calibration issues, and physical limitations of real-world photography. The surface normal data—critical vectors representing the orientation of the face surface—is particularly difficult to capture accurately from real subjects, as even the most sophisticated multi-camera rigs produce imperfect approximations of this geometric information.

In contrast, synthetic data generation creates computer-generated images of virtual people with mathematically perfect ground truth information. This approach provides precise control over every aspect of the facial geometry, including exact surface normal vectors that would be impossible to measure accurately from real photographs. The synthetic training data enables the model to focus on the most informative facial features for identity prediction through customizable landmark definition, allowing precise selection of key facial points like eye corners, lip boundaries, and jaw positions. This targeted approach lets the neural network ignore irrelevant background elements and concentrate exclusively on the facial regions that truly define a person's identity. The result is a more accurate and efficient 3-D face reconstruction system that can generate high-quality face meshes from a single 2-D image in real-time, making it ideal for applications in augmented reality, virtual reality, and digital avatar creation without requiring users to undergo cumbersome multi-angle photography sessions.

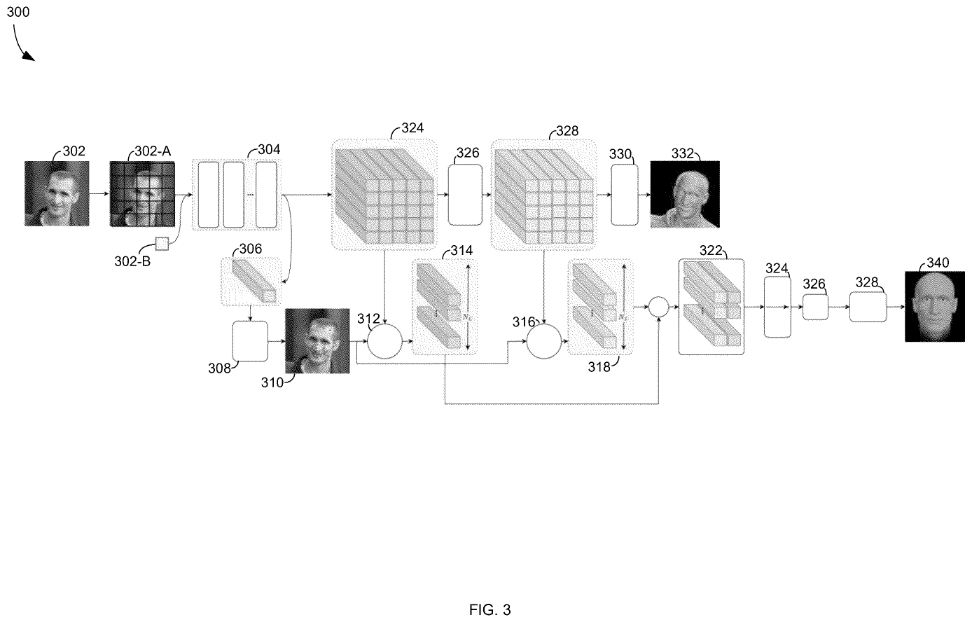

FIG. 3 illustrates a neural network architecture for geometry-aware monocular 3-D face reconstruction, showing components for patch generation, vision transformer encoding, surface normal estimation, landmark prediction, grid sampling, and identity parameter generation, consistent with some embodiments. The unified neural network model 300 shown in FIG. 3 processes a two-dimensional image 302 of a face to generate a three-dimensional mesh representation 340. Consistent with some embodiments, the process begins with the input image 302 being divided into non-overlapping patches 302-A through a patch extraction layer. This patch extraction is a pre-processing step that prepares the image for neural network processing by dividing it into manageable segments, typically of size 16×16 pixels, but by no means limited to such.

The image patches 302-A are then processed through a series of Vision Transformer (ViT) blocks 304, which form the backbone of the neural network architecture. These blocks 304 collectively function as an embedding layer and feature encoding layer. The embedding layer transforms each image patch into a corresponding embedding vector, while also generating a classification embedding token (CLS token) 306 that represents the entire two-dimensional image. The feature encoding layer then transforms these embedding vectors into visual tokens 324 representing image features for each image patch and transforms the classification embedding token into a compressed classification token containing global image information.

Consistent with some embodiments, the visual tokens 324 are processed through a geometric feature extraction layer 326 that analyzes the visual tokens to extract surface normal features 328 representing the three-dimensional geometry of the face in image space. This component forms a two-dimensional feature map from the visual tokens and processes it through a surface normal decoder 330 to generate a surface normal map 332. The surface normal features provide critical geometric information about the face that conventional approaches might miss, enabling the model to better preserve facial proportions and capture fine details like wrinkles.

In parallel, the compressed classification token 306 is processed through a landmark prediction layer 308 that generates a plurality of two-dimensional landmark coordinates 310 corresponding to specific facial features in the image. These landmarks identify important facial features such as eye corners, lip boundaries, eyebrows, and jaw positions. The landmark prediction component may also generate uncertainty estimates for each predicted landmark coordinate, allowing the model to account for prediction confidence in subsequent processing steps.

The visual tokens 324, surface normal features 328, and landmark coordinates 310 are then processed through grid sampling components 312 and 316. These components perform grid sampling at the landmark coordinates to extract combined feature vectors 318 containing both visual and geometric information at each facial landmark location. For example, given the 2-D coordinate of the tip of the nose, the system selects the visual token and surface normal feature at that coordinate, creating a rich representation that combines both appearance and geometric information.

The combined feature vectors 318 are then processed through an identity parameter generation layer 320 that transforms them into identity parameters 322 for a parametric face model. This component concatenates pooled features from the surface normal features and the visual tokens to create a context representation, which is then processed through a transformer decoder to generate identity coefficients. These identity parameters control face shape independently from head pose and expression, focusing specifically on capturing the unique facial identity of the person in the two-dimensional image.

Finally, the system generates a three-dimensional mesh representation 340 of the face by applying the identity parameters to the parametric face model 326 to deform a template mesh according to the facial identity of the person in the two-dimensional image. In this process, expression components and head pose parameters of the parametric face model are set to zero, ensuring that only the identity-specific aspects of the face are captured in the final mesh.

Consistent with some embodiments, the entire neural network model is trained end-to-end using synthetic face data comprising synthetic images of faces with corresponding ground-truth identity parameters, dense two-dimensional face landmarks, and surface normal maps. This unified training approach allows the model to learn the complex relationships between visual features, geometric information, and identity parameters, resulting in more accurate three-dimensional face reconstructions than conventional approaches that treat these aspects separately.

In various embodiments, the architecture may be modified in various ways. For example, the specific number of ViT blocks 304 may be adjusted based on computational constraints or accuracy requirements. Similarly, the dimensionality of the visual tokens 324 and surface normal features 328 may be varied to balance between computational efficiency and representation power. These design choices allow the system to be adapted for different deployment scenarios, from resource-constrained mobile devices to high-performance computing environments.

Consistent with some embodiments, the neural network model 300 illustrated in FIG. 3 undergoes a comprehensive end-to-end training process before deployment for inference. This training process is important to the ability of the model to generate accurate three-dimensional face meshes from single two-dimensional images.

Consistent with some embodiments, the training of the unified neural network model relies on synthetic data. This synthetic data comprises computer-generated face images 200 (as shown in FIG. 2) with corresponding face parameters including identity, expression, and pose information. Each synthetic face image is annotated with precise ground truth data, including identity parameters, dense 2-D face landmarks, surface normal maps, and depth information. This synthetic approach provides mathematically perfect ground truth information that would be difficult and expensive, if not nearly impossible, to obtain through conventional multi-camera setups with real subjects.

To train the model end-to-end, consistent with some embodiments, a combination of multiple specialized loss functions is employed, each targeting different aspects of the face reconstruction process. These loss functions work in concert to ensure the model learns to generate accurate three-dimensional face representations across various facial geometries and appearances.

The landmark loss function optimizes the landmark prediction component 308 by encouraging the model to predict landmark coordinates that maximize the likelihood of the ground truth landmarks. Specifically, the model uses a Gaussian Negative Log-Likelihood (GNLL) loss function:

Llandmark=Σ(i=1 to Nc)λi(log(σi²)+||μi−μi′||²/2σi²)

where μi′ is the ground truth location of landmark i, μi is the predicted location, σi² is the predicted uncertainty, and λi is a weighting factor. This loss function not only encourages accurate landmark prediction but also teaches the model to estimate its own uncertainty, which is valuable for subsequent processing steps.

The surface normal loss function, consistent with some embodiments, is applied to the output of the surface normal decoder 330 to ensure geometric accuracy. This loss computes the cosine similarity between normal vectors of the ground-truth normal map and the predicted normal map:

LNormal=1−(ngt·npred)/(|ngt|·|npred|)

This loss function guides the geometric feature extraction layer 326 to learn features that accurately represent the three-dimensional geometry of the face in image space. During training, this component generates a surface normal map 332 that is compared against ground truth, though at inference time only the surface normal features 328 are used.

The identity loss function, consistent with some embodiments, computes a simple L1 loss between the predicted identity coefficients and the ground-truth ones:

Lidentity=(1/N)Σ(i=1 to N)|βi−βi′|

where N=260 for the parametric face model. This loss ensures that the identity parameter generation layer 320 produces identity parameters 322 that accurately capture the unique facial characteristics of the person.

The mesh loss function, consistent with some embodiments, computes the per-vertex loss between the ground-truth and predicted meshes in their neutral expression. This is calculated by first obtaining the vertices of both meshes by setting the identity coefficients to the ground-truth and predicted values respectively, while setting head pose and expression components to zero. The L1 distance between corresponding vertices is then calculated:

Lmesh=(1/V)Σ(i=1 to V)|vi−vi′|

where V is the number of vertices in the mesh. This loss ensures that the final three-dimensional mesh representation 340 accurately reflects the facial geometry of the person in the input image.

During training, consistent with some embodiments, these loss functions are combined with appropriate weighting factors to form a total loss function that is minimized using gradient-based optimization methods. The synthetic training data allows for perfect supervision of all components, including those that would be difficult or impossible to supervise with real-world data, such as the surface normal features.

The end-to-end training approach allows the model to learn the complex relationships between visual features, geometric information, and identity parameters, resulting in a unified neural network that can generate accurate three-dimensional face reconstructions from a single image in real-time. This training methodology is a key factor in the ability of the model to preserve facial proportions and capture fine details like wrinkles, leading to significantly better likeness compared to conventional approaches.

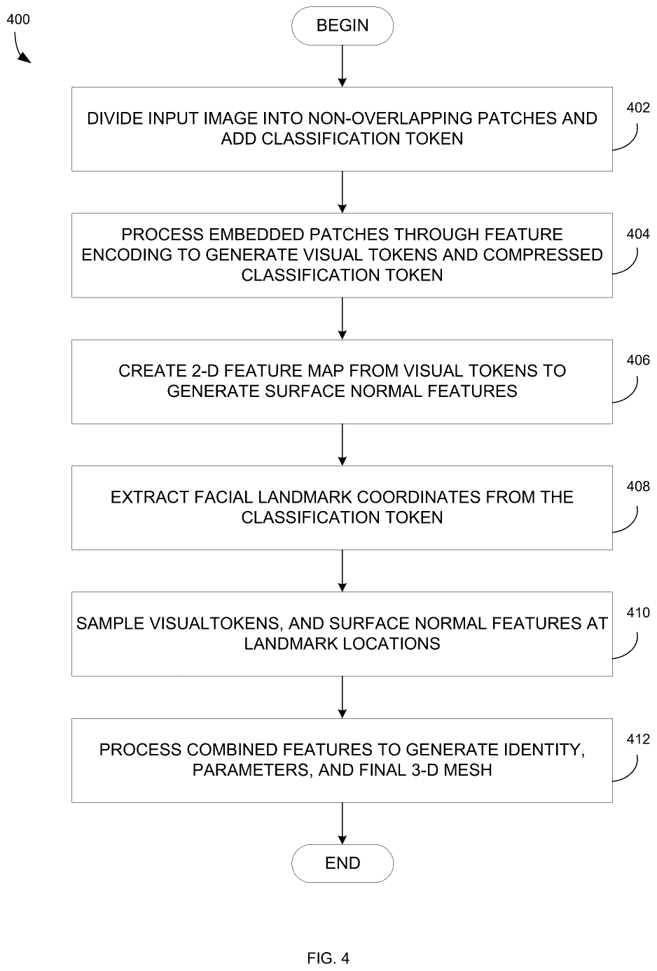

FIG. 4 illustrates a flowchart 400 showing operations performed by components of a unified neural network model for generating a three-dimensional mesh representation of a face from a two-dimensional image, consistent with some embodiments. A patch extraction layer performs the first operation 402 by dividing the input image into non-overlapping N×N pixel patches, typically 16×16 pixels, and vectorizing these patches. An embedding layer then transforms the vectorized patches into an embedding space to generate patch embeddings containing spatial and visual information specific to each patch region. The embedding layer also processes the two-dimensional image to generate a classification embedding token that aggregates global image information across all patches.

A feature encoding layer performs the second operation 404 by transforming the embedding vectors into visual tokens representing image features for each patch, including textures, wrinkles, and contours specific to each facial region. The feature encoding layer simultaneously transforms the classification embedding token into a compressed classification token that encodes both the spatial arrangement of elements within the image and visual characteristics of the image as a whole, including aggregate color, texture, and illumination.

A geometric feature extraction layer performs the third operation 406 by analyzing the visual tokens to extract surface normal features. This layer forms a two-dimensional feature map from the visual tokens and processes it through a surface normal decoder to generate a surface normal map. The layer then extracts surface normal features representing three-dimensional orientation vectors of the face surface. During training, the geometric feature extraction layer computes a cosine similarity between normal vectors of the generated surface normal map and ground-truth normal vectors to optimize feature extraction.

A landmark prediction layer performs the fourth operation 408 by processing the compressed classification token to generate two-dimensional landmark coordinates corresponding to specific facial features. The layer predicts coordinates for eye corners, lip boundaries, eyebrows, and jaw positions—regions containing distinguishing geometric and visual characteristics. The landmark prediction layer also generates uncertainty estimates for each predicted landmark coordinate to quantify confidence levels in the coordinate predictions during model training.

A feature sampling layer performs the fifth operation 410 by conducting grid sampling at the landmark coordinates. At each coordinate, the layer extracts appearance-based visual information from the visual tokens, including texture patterns, wrinkles, skin features, and local contrast variations that characterize the visual appearance of that facial region. The layer also extracts geometry-based surface normal information including three-dimensional orientation vectors that define surface curvature, depth transitions, and geometric shape. These are combined into unified feature vectors that jointly encode appearance characteristics and three-dimensional geometric structure at each facial landmark location.

An identity parameter generation layer performs the sixth operation 412 by transforming the combined feature vectors into identity parameters. This layer concatenates pooled features from the surface normal features and visual tokens to create a context representation containing both geometric-based and appearance-based information. A transformer decoder within this layer then processes the context representation to generate identity coefficients that encode unique facial characteristics, controlling facial structure, proportions, and distinguishing features independently from head pose and expression parameters.

Finally, a parametric face model generates the three-dimensional mesh representation by having its expression components and head pose parameters set to zero to isolate facial identity characteristics. The model applies only the generated identity parameters that control facial structure, proportions, and distinguishing features to deform a template mesh. The model then generates vertices of the three-dimensional mesh representation based on the deformed template mesh, with the vertices defining a three-dimensional geometry representing the unique facial identity of the person.

Consistent with some embodiments, the entire neural network model implementing this method is trained end-to-end using synthetic face data comprising synthetic images of faces with corresponding ground-truth identity parameters, dense two-dimensional face landmarks, and surface normal maps. This unified training approach allows the model to learn the complex relationships between visual features, geometric information, and identity parameters, resulting in more accurate three-dimensional face reconstructions than conventional approaches that treat these aspects separately.

The ability of the model to generate accurate 3-D face meshes from a single 2-D image in real-time makes it particularly valuable for applications in augmented reality, virtual reality, and digital avatar creation, where users can instantly generate realistic avatars that capture their unique facial identity.

### Machine and Software Architecture

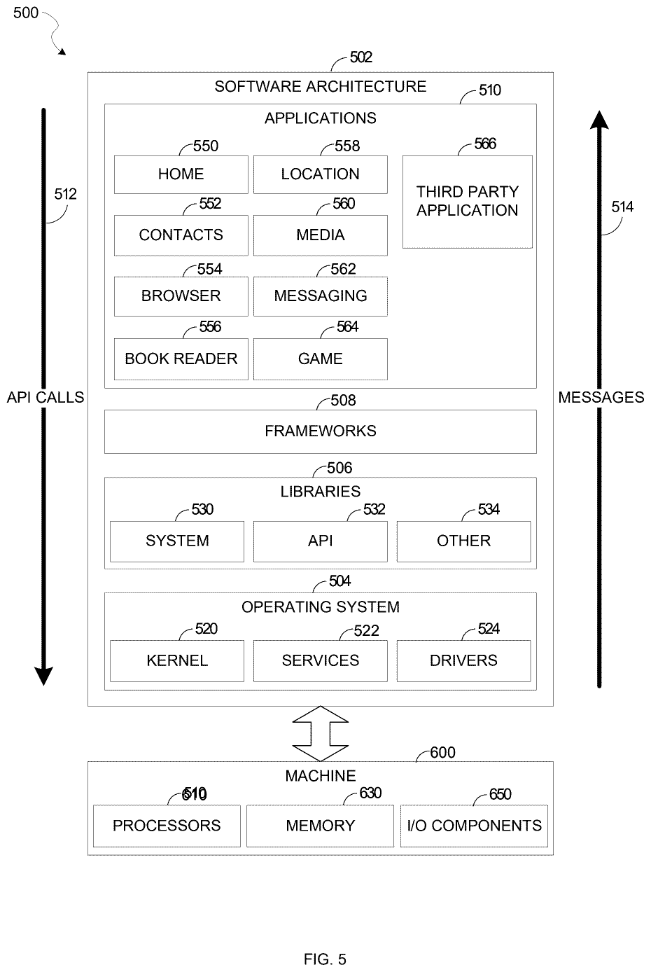

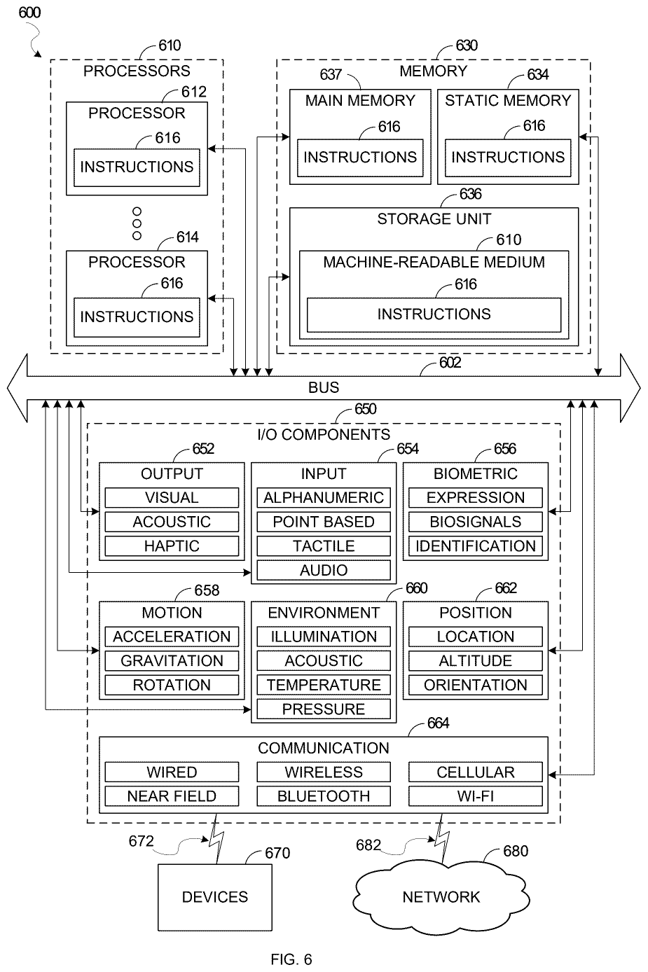

FIG. 5 is a block diagram 500 illustrating a software architecture 502, which can be installed on any of a variety of computing devices to perform methods consistent with those described herein. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that includes processors 610, memory 630, and input/output (I/O) components 650. In this example architecture, the software architecture 502 can be conceptualized as a stack of layers where each layer may provide a particular functionality. For example, the software architecture 502 includes layers such as an operating system 504, libraries 506, frameworks 508, and applications 510. Operationally, the applications 510 invoke API calls 512 through the software stack and receive messages 514 in response to the API calls 512, consistent with some embodiments.

In various embodiments, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionality. The services 522 can provide other common services for the other software layers. The drivers 524 are responsible for controlling or interfacing with the underlying hardware, according to some embodiments. For instance, the drivers 524 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2-D) and three dimensions (3-D) in a graphic context on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510, according to some embodiments. For example, the frameworks 508 provide various GUI functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications, such as a third-party application 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine to perform any one or more of the methodologies discussed herein, according to an example embodiment. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example the instructions 616 may cause the machine 600 to execute any one of the methods or algorithmic techniques described herein. Additionally, or alternatively, the instructions 616 may implement any one of the systems described herein. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions contemporaneously. Although FIG. 6 shows multiple processors 610, the machine 600 may include a single processor with a single core, a single processor with multiple cores (e.g., a multi-core processor), multiple processors with a single core, multiple processors with multiples cores, or any combination thereof.

The memory 630 may include a main memory 632, a static memory 634, and a storage unit 636, all accessible to the processors 610 such as via the bus 602. The main memory 630, the static memory 634, and storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile devices will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 662 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a USB).

Moreover, the communication components 664 may detect identifiers or include components operable to detect identifiers. For example, the communication components 664 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2-D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 630, 632, 634, and/or memory of the processor(s) 610) and/or storage unit 636 may store one or more sets of instructions and data structures (e.g., software) embodying or utilized by any one or more of the methodologies or functions described herein. These instructions (e.g., the instructions 616), when executed by processor(s) 610, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 680 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., HTTP). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A method, implemented by a neural network model, for generating a three-dimensional mesh representation of a face from a two-dimensional image of the face, the method comprising:
receiving the two-dimensional image of the face;
processing the two-dimensional image through a patch extraction layer to divide the two-dimensional image into a plurality of image patches;
processing the image patches through an embedding layer to transform each image patch into a corresponding embedding vector;
processing the two-dimensional image through the embedding layer to generate a classification embedding token for the two-dimensional image;
processing the embedding vectors through a feature encoding layer to transform the embedding vectors into visual tokens representing image features for each image patch, the image features representing visual characteristics including textures, wrinkles, and contours, specific to a region of the face corresponding to the image patch;
processing the classification embedding token through a feature encoding layer to transform the classification embedding token into a compressed classification token encoding information relating to both (i) a spatial arrangement of elements within the image and (ii) visual characteristics of the image as a whole, including one or more of aggregate color, texture, and illumination;
processing the visual tokens through a geometric feature extraction layer to analyze the visual tokens and to extract surface normal features, by:
forming a two-dimensional feature map from the visual tokens;
processing the two-dimensional feature map through a surface normal decoder to generate a surface normal map; and
extracting, from the surface normal map, the surface normal features representing three-dimensional orientation vectors of the face surface;
processing the compressed classification token through a landmark prediction layer to generate a plurality of two-dimensional landmark coordinates corresponding to specific facial features in the two-dimensional image;
processing the visual tokens, the surface normal features, and the landmark coordinates through a feature sampling layer to perform grid sampling at the landmark coordinates to extract combined feature vectors containing both appearance-based visual information and geometry-based surface normal information at each facial landmark location;
processing the combined feature vectors through an identity parameter generation layer to transform the combined feature vectors into identity parameters that control unique facial structure, proportions, and features that distinguish a face of an individual; and
generating a three-dimensional mesh representation of the face by applying the identity parameters to a parametric face model to deform a template mesh according to the facial identity of a person in the two-dimensional image.

2. The method of claim 1, wherein processing the visual tokens through the geometric feature extraction layer to extract surface normal features comprises:
forming a two-dimensional feature map from the visual tokens;
processing the two-dimensional feature map through a surface normal decoder to generate a surface normal map; and
computing a cosine similarity between normal vectors of the generated surface normal map and ground-truth normal vectors during training of the neural network model to optimize extraction of the surface normal features.

3. The method of claim 1, wherein processing the compressed classification token through the landmark prediction layer to generate the plurality of two-dimensional landmark coordinates comprises:
predicting coordinates for specific facial features including eye corners, lip boundaries, eyebrows, and jaw positions, wherein the specific facial features correspond to regions of the face containing distinguishing geometric and visual characteristics; and
generating uncertainty estimates for each predicted landmark coordinate to quantify confidence levels in the coordinate predictions during training of the neural network model.

4. The method of claim 1, wherein processing the combined feature vectors through the identity parameter generation layer to transform the combined feature vectors into identity parameters comprises:
concatenating pooled features from the surface normal features and the visual tokens to create a context representation containing both geometric-based and appearance-based information about the face;
processing the context representation through a transformer decoder to generate identity coefficients that encode unique facial characteristics; and
wherein the identity coefficients control facial structure, proportions, and distinguishing features independently from head pose and expression parameters of the parametric face model.

5. The method of claim 1, wherein processing the image patches through the embedding layer and processing the two-dimensional image through the embedding layer to transform each image patch into a corresponding embedding vector and to generate the classification embedding token comprises:
vectorizing the image patches, wherein each patch is non-overlapping and comprises N×N pixels;
transforming the vectorized patches into an embedding space using the embedding layer to generate patch embeddings containing spatial and visual information specific to each patch region; and
adding the classification embedding token before processing through the feature encoding layer, wherein the classification embedding token aggregates global image information across all patches.

6. The method of claim 1, wherein generating the three-dimensional mesh representation of the face by applying the identity parameters to the parametric face model comprises:
setting expression components and head pose parameters of the parametric face model to zero to isolate facial identity characteristics from expression and pose variations;
applying only the generated identity parameters that control facial structure, proportions, and distinguishing features to deform the template mesh; and
generating vertices of the three-dimensional mesh representation based on the deformed template mesh, wherein the vertices define a three-dimensional geometry representing the unique facial identity of the person.

7. The method of claim 1, wherein the neural network model implementing the method is trained end-to-end using synthetic face data comprising:
synthetic images of faces with corresponding ground-truth identity parameters;
dense two-dimensional face landmarks; and
surface normal maps.

8. The method of claim 1, wherein processing the visual tokens, surface normal features, and landmark coordinates through the feature sampling layer to extract combined feature vectors comprises:
extracting, at each landmark coordinate, appearance-based visual information from the visual tokens including texture patterns, wrinkles, skin features, and local contrast variations that characterize visual appearance of the facial region corresponding to that landmark;
extracting, at each landmark coordinate, geometry-based surface normal information from the surface normal features including three-dimensional orientation vectors that define surface curvature, depth transitions, and geometric shape of the facial region corresponding to that landmark; and
combining the extracted appearance-based visual information and geometry-based surface normal information into unified feature vectors that jointly encode appearance characteristics and three-dimensional geometric structure at each facial landmark location.

9. The method of claim 1, wherein generating the three-dimensional mesh representation of the face from a two-dimensional image of the face comprises receiving as input to the neural network model a single two-dimensional image of the face.

10. A system, implemented with a neural network model, for generating a three-dimensional mesh representation of a face from a two-dimensional image of the face, the system comprising:
at least one processor; and
at least one memory storage device, storing instructions thereon, which, when executed by the at least one processor of the system, cause the system to perform operations comprising:
receiving the two-dimensional image of the face;
processing the two-dimensional image through a patch extraction layer to divide the two-dimensional image into a plurality of image patches;
processing the image patches through an embedding layer to transform each image patch into a corresponding embedding vector;
processing the two-dimensional image through the embedding layer to generate a classification embedding token for the two-dimensional image;
processing the embedding vectors through a feature encoding layer to transform the embedding vectors into visual tokens representing image features for each image patch, the image features representing visual characteristics including textures, wrinkles, and contours, specific to a region of the face corresponding to the image patch;
processing the classification embedding token through a feature encoding layer to transform the classification embedding token into a compressed classification token encoding information relating to both (i) a spatial arrangement of elements within the image and (ii) visual characteristics of the image as a whole, including one or more of aggregate color, texture, and illumination;
processing the visual tokens through a geometric feature extraction layer to analyze the visual tokens and to extract surface normal features, by:
forming a two-dimensional feature map from the visual tokens;
processing the two-dimensional feature map through a surface normal decoder to generate a surface normal map; and
extracting, from the surface normal map, the surface normal features representing three-dimensional orientation vectors of the face surface;
processing the compressed classification token through a landmark prediction layer to generate a plurality of two-dimensional landmark coordinates corresponding to specific facial features in the two-dimensional image;
processing the visual tokens, the surface normal features, and the landmark coordinates through a feature sampling layer to perform grid sampling at the landmark coordinates to extract combined feature vectors containing both appearance-based visual information and geometry-based surface normal information at each facial landmark location;
processing the combined feature vectors through an identity parameter generation layer to transform the combined feature vectors into identity parameters that control unique facial structure, proportions, and features that distinguish a face of an individual; and
generating a three-dimensional mesh representation of the face by applying the identity parameters to a parametric face model to deform a template mesh according to the facial identity of a person in the two-dimensional image.

11. The system of claim 10, wherein processing the visual tokens through the geometric feature extraction layer to extract surface normal features comprises:
forming a two-dimensional feature map from the visual tokens;
processing the two-dimensional feature map through a surface normal decoder to generate a surface normal map; and
computing a cosine similarity between normal vectors of the generated surface normal map and ground-truth normal vectors during training of the neural network model to optimize extraction of the surface normal features.

12. The system of claim 10, wherein processing the compressed classification token through the landmark prediction layer to generate the plurality of two-dimensional landmark coordinates comprises:
predicting coordinates for specific facial features including eye corners, lip boundaries, eyebrows, and jaw positions, wherein the specific facial features correspond to regions of the face containing distinguishing geometric and visual characteristics; and
generating uncertainty estimates for each predicted landmark coordinate to quantify confidence levels in the coordinate predictions during training of the neural network model.

13. The system of claim 10, wherein processing the combined feature vectors through the identity parameter generation layer to transform the combined feature vectors into identity parameters comprises:
concatenating pooled features from the surface normal features and the visual tokens to create a context representation containing both geometric-based and appearance-based information about the face;
processing the context representation through a transformer decoder to generate identity coefficients that encode unique facial characteristics; and
wherein the identity coefficients control facial structure, proportions, and distinguishing features independently from head pose and expression parameters of the parametric face model.

14. The system of claim 10, wherein processing the image patches through the embedding layer and processing the two-dimensional image through the embedding layer to transform each image patch into a corresponding embedding vector and to generate the classification embedding token comprises:
vectorizing the image patches, wherein each patch is non-overlapping and comprises N×N pixels;
transforming the vectorized patches into an embedding space using the embedding layer to generate patch embeddings containing spatial and visual information specific to each patch region; and
adding the classification embedding token before processing through the feature encoding layer, wherein the classification embedding token aggregates global image information across all patches.

15. The system of claim 10, wherein generating the three-dimensional mesh representation of the face by applying the identity parameters to the parametric face model comprises:
setting expression components and head pose parameters of the parametric face model to zero to isolate facial identity characteristics from expression and pose variations;
applying only the generated identity parameters that control facial structure, proportions, and distinguishing features to deform the template mesh; and
generating vertices of the three-dimensional mesh representation based on the deformed template mesh, wherein the vertices define a three-dimensional geometry representing the unique facial identity of the person.

16. The system of claim 10, wherein the neural network model is trained end-to-end using synthetic face data comprising:
synthetic images of faces with corresponding ground-truth identity parameters;
dense two-dimensional face landmarks; and
surface normal maps.

17. The system of claim 10, wherein processing the visual tokens, surface normal features, and landmark coordinates through the feature sampling layer to extract combined feature vectors comprises:
extracting, at each landmark coordinate, appearance-based visual information from the visual tokens including texture patterns, wrinkles, skin features, and local contrast variations that characterize visual appearance of the facial region corresponding to that landmark;
extracting, at each landmark coordinate, geometry-based surface normal information from the surface normal features including three-dimensional orientation vectors that define surface curvature, depth transitions, and geometric shape of the facial region corresponding to that landmark; and
combining the extracted appearance-based visual information and geometry-based surface normal information into unified feature vectors that jointly encode appearance characteristics and three-dimensional geometric structure at each facial landmark location.

18. The system of claim 10, wherein generating the three-dimensional mesh representation of the face from a two-dimensional image of the face comprises receiving as input to the neural network model a single two-dimensional image of the face.

19. One or more memory storage devices, storing instructions thereon, which, when executed by one or more processors, cause the one or more processors to perform operations comprising:
receiving a single two-dimensional image of a face;
processing the two-dimensional image through a patch extraction layer to divide the two-dimensional image into a plurality of image patches;
processing the image patches through an embedding layer to transform each image patch into a corresponding embedding vector;
processing the two-dimensional image through the embedding layer to generate a classification embedding token for the two-dimensional image;
processing the embedding vectors through a feature encoding layer to transform the embedding vectors into visual tokens representing image features for each image patch, the image features representing visual characteristics including textures, wrinkles, and contours, specific to a region of the face corresponding to the image patch;
processing the classification embedding token through a feature encoding layer to transform the classification embedding token into a compressed classification token encoding information relating to both (i) a spatial arrangement of elements within the image and (ii) visual characteristics of the image as a whole, including one or more of aggregate color, texture, and illumination;
processing the visual tokens through a geometric feature extraction layer to analyze the visual tokens and to extract surface normal features, by:
forming a two-dimensional feature map from the visual tokens;
processing the two-dimensional feature map through a surface normal decoder to generate a surface normal map; and
extracting, from the surface normal map, the surface normal features representing three-dimensional orientation vectors of the face surface;
processing the compressed classification token through a landmark prediction layer to generate a plurality of two-dimensional landmark coordinates corresponding to specific facial features in the two-dimensional image;
processing the visual tokens, the surface normal features, and the landmark coordinates through a feature sampling layer to perform grid sampling at the landmark coordinates to extract combined feature vectors containing both appearance-based visual information and geometry-based surface normal information at each facial landmark location;
processing the combined feature vectors through an identity parameter generation layer to transform the combined feature vectors into identity parameters that control unique facial structure, proportions, and features that distinguish a face of an individual; and
generating a three-dimensional mesh representation of the face by applying the identity parameters to a parametric face model to deform a template mesh according to the facial identity of a person in the two-dimensional image.

20. The one or more memory storage devices of claim 19, wherein processing the visual tokens through the geometric feature extraction layer to extract surface normal features comprises:
forming a two-dimensional feature map from the visual tokens;
processing the two-dimensional feature map through a surface normal decoder to generate a surface normal map; and
computing a cosine similarity between normal vectors of the generated surface normal map and ground-truth normal vectors during training of a neural network model to optimize extraction of the surface normal features.
